(19) United States
(12) Patent Application Publication
(10) Pub. No.: US 2015/0130915 A1
(43) Pub. Date: May 14, 2015

(54) APPARATUS AND SYSTEM FOR DYNAMIC ADJUSTMENT OF DEPTH FOR STEREOSCOPIC VIDEO CONTENT

(71) Applicant: NVIDIA Corporation, Santa Clara, CA (US)

(72) Inventors: Nilesh Angadrao More, Pune (IN); Harsha Kumar CC, Bangalore (IN); Saurabh Kumar, Hyderabad (IN)

(73) Assignee: NVIDIA Corporation, Santa Clara, CA (US)

(21) Appl. No.: 14/076,112

(22) Filed: Nov. 8, 2013

(51) Int. Cl. H04N 13/00; G02B 27/22; G02B 27/26; H04N 13/04

(52) U.S. Cl. CPC H04N 13/0022; H04N 13/0429; H04N 13/0497; G02B 27/2228; G02B 27/26
USPC 348/57; 348/55

(57) ABSTRACT

An apparatus and system are provided for adjusting the depth of stereoscopic video content. The apparatus comprises a frame that supports a first lens and a second lens. The first lens is associated with a first image in a stereoscopic image pair and the second lens is associated with a second image in the stereoscopic image pair. An interface for controlling a parameter associated with the stereoscopic image pair is integrated into the frame of the apparatus. The system includes a display device configured to display stereoscopic video content and coupled to the apparatus for controlling the stereoscopic video content.

### FIELD OF THE INVENTION

The present invention relates to stereoscopic video, and more particularly to techniques for adjusting the depth of field in stereoscopic video.

### BACKGROUND

Depth is perceived, in part, based on binocular disparity, which is the difference in images captured from slightly offset locations. For example, the average human has eyes that are located approximately two and a half inches apart. The different images seen by the eyes are resolved by the brain to perceive depth. Additional depth cues may be provided based on parallax. Computer-generated stereoscopic video data may be created by rendering a three-dimensional scene from two different camera positions. The camera positions may be offset by a particular distance in order to generate a left image and a right image. The stereoscopic video data is then viewed using polarized glasses such that the left image is viewed by the left eye and the right image is viewed by the right eye.

The level of binocular disparity provides different depth cues to a brain that help a viewer resolve the depth of an object in a scene. For example, large binocular disparity allows a viewer to perceive depth of objects that are farther away from the camera. However, large binocular disparity also allows the viewer to see “around” objects that are close to the camera position, which can be discomforting to a viewer. Conversely, small binocular disparity may allow a viewer to perceive depth of objects that are close to the camera, but objects further away from the camera appear to be flat (i.e., have no depth). Different stereoscopic techniques may be implemented to avoid problems for viewers such as headaches caused by poor stereoscopic technique. For example, care should be taken to avoid objects at different locations in the left image and right image that would cause a viewer's eyes to diverge because viewer's eyes naturally are only parallel when focusing on an object located at infinity or converge on objects located close to the viewer.

Many viewers react to stereoscopic video content in different ways. Some viewers may feel more comfortable watching video generated based on one binocular disparity compared to another. Furthermore, the binocular disparity that a viewer may feel comfortable watching is affected by the size of the screen and the viewer's distance from the screen, which inevitably affects the angle of a viewer's eyes attempting to focus on the same object located at different locations in a left image and a right image, It would be useful to allow a viewer to easily adjust the binocular disparity associated with stereoscopic video content. Thus, there is a need for addressing these issues and/or other issues associated with the prior art.

### SUMMARY

An apparatus and system are provided for adjusting the depth of stereoscopic video content. The apparatus comprises a frame that supports a first lens and a second lens. The first lens is associated with a first image in a stereoscopic image pair and the second lens is associated with a second image in the stereoscopic image pair. An interface for controlling a parameter associated with the stereoscopic image pair is integrated into the frame of the apparatus. The system includes a display device configured to display stereoscopic video content and coupled to the apparatus for controlling the stereoscopic video content.

### BRIEF DESCRIPTION OF THE DRAWINGS

FIGS. 1A & 1B illustrate a pair of stereoscopic glasses, in accordance with the prior art;

FIGS. 2A & 2B illustrate a pair of stereoscopic glasses, in accordance with one embodiment;

FIG. 3 illustrates a system for adjusting the depth of stereoscopic video content, in accordance with one embodiment;

FIG. 4 illustrates a system including multiple pairs of stereoscopic glasses, in accordance with one embodiment;

FIG. 5 illustrates a system including multiple pairs of stereoscopic glasses, in accordance with another embodiment;

FIG. 6 illustrates a system including multiple pairs of stereoscopic glasses, in accordance with yet another embodiment; and

FIG. 7 illustrates an exemplary system in which the various architecture and/or functionality of the various previous embodiments may be implemented.

### DETAILED DESCRIPTION

Stereoscopic glasses are becoming more common with today's resurgence of three-dimensional (3D) HDTV (High-Definition Television) for the home consumer market. Many of today's mid-range to high-end light-emitting diode (LED) television devices are capable of displaying stereoscopic video content. With a refresh rate of 120 or 240 Hz, the HDTV devices alternate display of left and right images on the screen. A pair of active stereoscopic glasses worn by a viewer is synchronized to the television such that a left liquid crystal display (LCD) lens is translucent when a left image is displayed on the screen and a right LCD lens is translucent when a right image is displayed on the screen. Similarly, the left LCD lens is opaque when the right image is displayed on the screen and the right LCD lens is opaque when the left image is displayed on the screen.

Conventional stereoscopic glasses may include a button to turn on the power used to control the LCD lens, but any other controls associated with the stereoscopic video content are either located on a remote control for the display device (e.g., for HDTVs) or via software associated with the display device (e.g., for desktop computers having a 3D enabled monitor). Controls may be added to the stereoscopic glasses that let a user control various aspects of the stereoscopic video content directly from their person, simply by reaching up and adjusting the control interface on the side of the stereoscopic glasses. Such a device eases operation for a user, for example, by letting the user remain on the couch while adjusting the stereoscopic video content and not requiring the user to walk over to the display device to adjust said content.

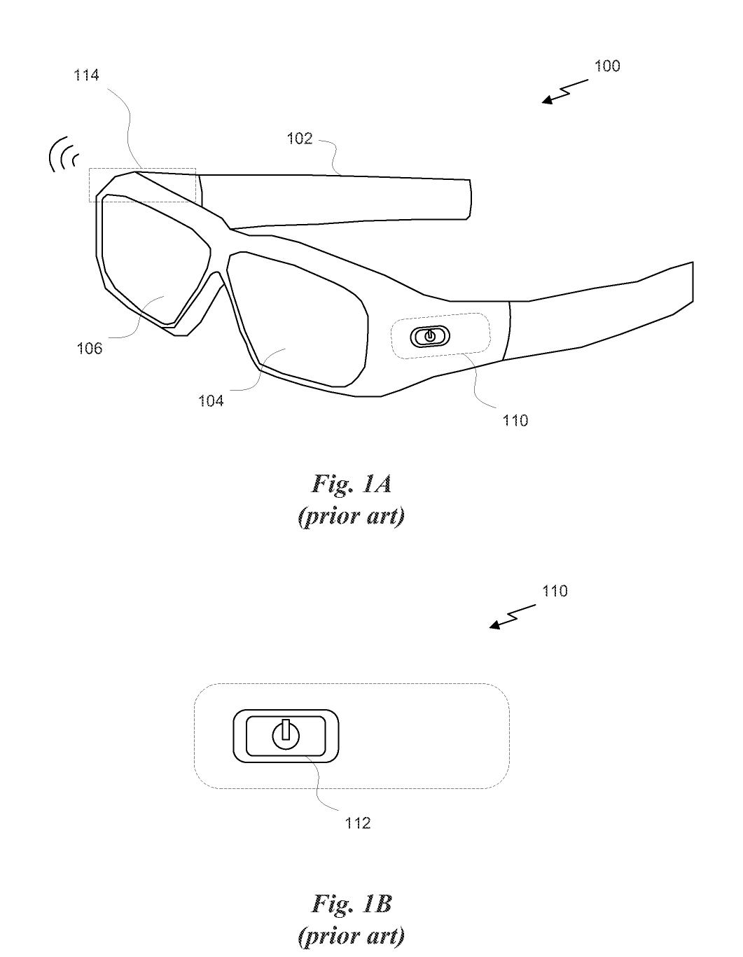

FIGS. 1A & 1B illustrate a pair of stereoscopic glasses 100, in accordance with the prior art. As shown in FIG. 1A, the stereoscopic glasses 100 are active stereoscopic glasses that include a left lens 104 and a right lens 106. Each of the lenses 104, 106 may comprise a liquid crystal layer that, when a voltage is applied to the layer, causes the liquid crystals to twist, thereby turning the lens opaque. When the voltage is not applied to the layer, then the lenses 104, 106 are translucent. The lenses 104, 106 are supported by a frame 102 that is made of a plastic or metal material. Although not shown explicitly, the stereoscopic glasses 100 may include a power source such as a battery. The battery is used to control the operation of the lenses 104, 106 by applying a voltage to the liquid crystal layer. Alternatively, the glasses may be wired to a computer or stereoscopic controller via a USB (Universal Serial Bus) cable, which may provide a 5V power source. As shown in FIG. 1B, the stereoscopic glasses 100 may include a power button 112 integrated into a portion 110 of the frame 102.

In normal operation, the stereoscopic glasses 100 are synchronized with stereoscopic content displayed on a display device. The stereoscopic content may be displayed, e.g., at 120 Hz, alternating between a left image and a right image 120 times per second. The stereoscopic glasses 100 are synchronized with the display device such that when a left image is displayed on the display device, the left lens 104 is translucent and the right lens 106 is opaque, and when a right image is displayed on the display device, the right lens 106 is translucent and the left lens 104 is opaque. The stereoscopic glasses 100 may be synchronized with the display device based on a synchronization signal transmitted via radio frequency, infrared, Bluetooth®, or any other transmission means well-known in the art. As shown, the stereoscopic glasses 100 include a receiver 114 for detecting the synchronization signal generated by the display device.

It will be appreciated that such stereoscopic glasses 100 are configured for one-way communication. The stereoscopic glasses 100 receive a signal from the display device that enables the lenses 104, 106 to be operated in a manner that is consistent with the display of the left and right images on the screen of the display device. The capabilities of the stereoscopic glasses may be expanded by enabling two-way communication.

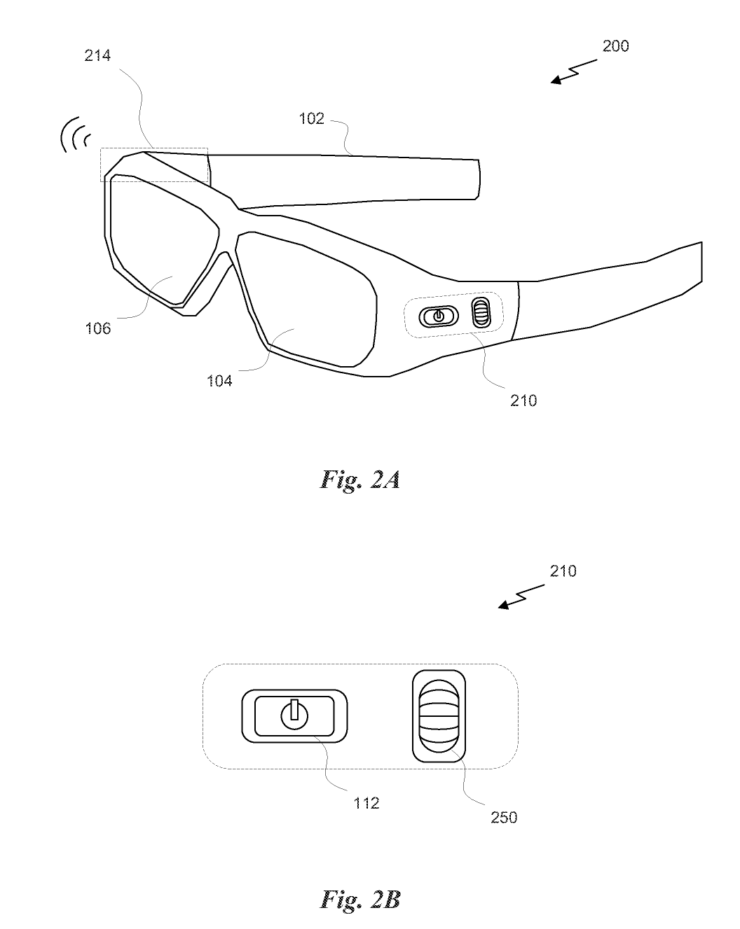

FIGS. 2A & 2B illustrate a pair of stereoscopic glasses 200, in accordance with one embodiment. As shown in FIG. 2A, the stereoscopic glasses 200 also include a left lens 104 and a right lens 106 supported by a frame 102. The left lens 104, right lens 106, and frame 102 are described above in conjunction with stereoscopic glasses 100. Stereoscopic glasses 200 also include a power source such as a battery or wired power connection via, e.g., a USB cable. Unlike stereoscopic glasses 100, the stereoscopic glasses 200 include a transceiver 214 in lieu of the receiver 114 included in stereoscopic glasses 100. The transceiver 214 enables two-way communication with a corresponding transceiver associated with the display device. The transceiver 214 may communicate with the corresponding transceiver via radio frequency, infrared, Bluetooth®, or any other wireless or wired transmission means. In an embodiment where the stereoscopic glasses 200 are coupled to the display device via a wired connection such as a USB cable, the functionality of the transceiver 214 may be implemented via the wired interface, such as transmitting the synchronization signal and/or the control signal via a USB controller according to the standard USB protocol. This hardware enables various interface components to be integrated into the stereoscopic glasses 200.

As shown in FIG. 2B, a portion 210 of the frame 102 includes various interface components such as the power button 112. In addition to the power button 112, the stereoscopic glasses 200 include an interface 250 for controlling the depth of the stereoscopic video content being displayed on the display device. As used here, depth of stereoscopic video content refers to a binocular disparity associated with the stereoscopic video content. In other words, the depth refers to a distance between two camera positions corresponding to the left image and the right image for each frame of image data included in the stereoscopic video content. In one embodiment, the interface 250 comprises a wheel such as commonly found on many mouse devices. The wheel may be configured to sense a direction of rotation, clockwise or counterclockwise. In one embodiment, when a user turns the wheel counterclockwise when viewed from the front of the stereoscopic glasses 200 (i.e., “up”), the binocular disparity associated with the stereoscopic video content is increased, and when a user turns the wheel clockwise when viewed from the front of the stereoscopic glasses 200, the binocular disparity associated with the stereoscopic video content is decreased. It will be appreciated that the direction of rotation for controlling increasing or decreasing the binocular disparity is arbitrary and other embodiments may reverse the direction. In another embodiment, the interface 250 may comprise some other type of human interface hardware such as a pair of buttons including a first button for increasing the binocular disparity when the first button is depressed and a second button for decreasing the binocular disparity when the second button is depressed. The buttons may be mechanical in design or touch-based, capacitive sensors.

In another embodiment, the stereoscopic glasses 200 may include other interface components in addition to, or in lieu of the interface 250. For example, the stereoscopic glasses 210 may include a button to enable or disable stereoscopic video. When the button causes the stereoscopic video to be disabled, the display device displays 2D content (i.e., content with no left and right image) and both lenses 104, 106 of the stereoscopic glasses 200 are made translucent. The stereoscopic glasses 200 may include buttons for playing, stopping, pausing, fast-forwarding, and rewinding the stereoscopic video content. The stereoscopic glasses 200 may also include an interface for adjusting the brightness or contrast of the display screen, changing the refresh rate of the display screen, and so forth.

It will be appreciated that changing the depth associated with stereoscopic video content that is generated at interactive frame rates by a computer based on a 3D model and displayed on the display device can be accomplished by changing the camera position associated with the rendering of a particular frame of image data in the stereoscopic video content, Because this content is generated substantially in real-time, and the binocular disparity associated with the content may be changed based on, e.g., a command transmitted to the rendering engine, controlling the depth of the stereoscopic video content is relatively straightforward. However, it will be appreciated that some of today's high-end televisions may also include video processing engines that can process stereoscopic video content to adjust the depth of the stereoscopic video content. For example, a stereoscopic processing engine may receive stereoscopic video content produced by a content provider. A left image and a right image may be extracted from the stereoscopic video content. Pixels of various objects included in the left image and the right image may be compared to determine a disparity in pixels on the screen. The pixels associated with such objects may be copied to corresponding pixels such that a screen space disparity associated with corresponding pixels is adjusted. Various algorithms may be implemented to replace pixels that are left empty based on such operations, such as copying pixel values from neighboring pixels, copying pixel values from the corresponding left of right image, or copying pixel values from temporally adjacent frames of image data.

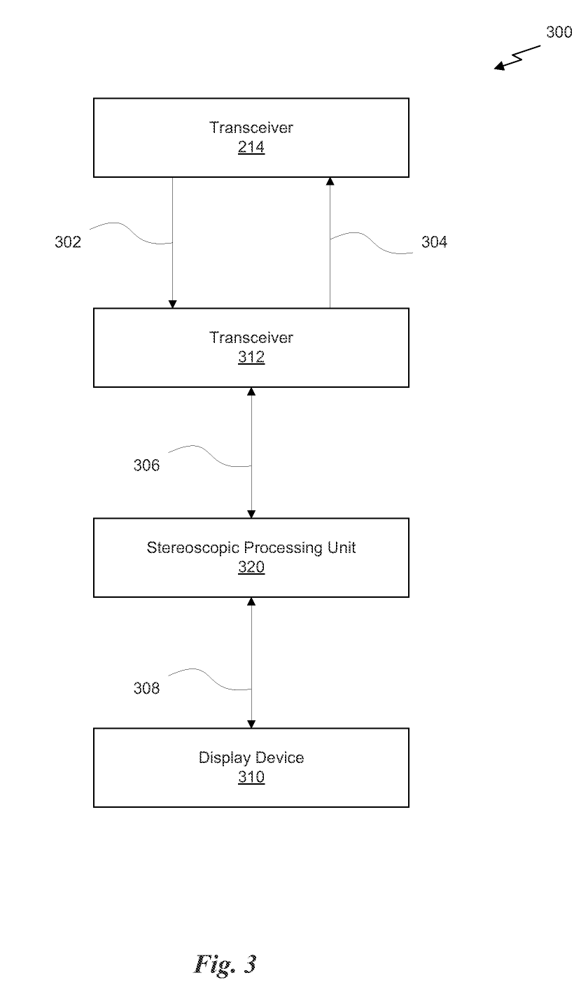

FIG. 3 illustrates a system 300 for adjusting the depth of stereoscopic video content 308, in accordance with one embodiment. As shown in FIG. 3, the transceiver 214 included in the stereoscopic glasses 200 is configured to communicate with a corresponding transceiver 312 associated with a display device 310. The transceiver 312 transmits a synchronization signal 304 to the transceiver 214. The synchronization signal 304 is associated with the refresh rate of the display device 310 such that a pulse of the synchronization signal corresponds to a vertical synchronization period (VSYNC) of the stereoscopic video signal that represents a transition from one image to another image. The transceiver 312 is coupled to a stereoscopic processing unit 320 that is configured to generate the stereoscopic video content 308 for display on the display device. The transceiver 312 may also receive a control signal 302 from the transceiver 214. The control signal 302 may indicate whether the user has used the interface 250 to adjust the binocular disparity associated with the stereoscopic video content. In one embodiment, the control signal 302 may indicate simply that the user has interacted with the interface 250 (i.e., indicating a button has been pressed, the wheel has moved, etc.). In another embodiment, the control signal 302 may indicate a new binocular disparity value to be used when generating the stereoscopic video content.

The stereoscopic processing unit 320 may receive information associated with the control signal 302 from the transceiver 312 and may generate information related to the synchronization signal 304 that is transmitted to the transceiver 312 via interface 306. In one embodiment, the interface 306 is a system bus or other peripheral bus of the device including the stereoscopic processing unit 320 and the transceiver 312. In another embodiment, the interface 306 is a USB interface. In such an embodiment, the transceiver 312 may be included in a USB device that plugs into the display device 310. The USB device may generate the synchronization signal 304 based on the VSYNC pulse of the stereoscopic video content displayed on the display device 310. Furthermore, the USB device may receive the control signal from the transceiver 214 and configure the stereoscopic processing unit 320 to generate the stereoscopic video content based on a new binocular disparity.

In one embodiment, the stereoscopic processing unit 320 is a graphics processing unit (GPU) included in a computer system such as a desktop computer system, a laptop computer system, a tablet device, and the like. The GPU may be configured to render graphics data, such as data that represents a 3D model of a scene, to generate images for display on the attached display device 310. The GPU may also be coupled to a host processor such as a central processing unit (CPU). The CPU may execute a device driver for the GPU that enables an application, such as a Control Panel Application that provides a graphical user interface for a user to adjust settings related to the stereoscopic video content. The application may provide an interface that can be adjusted by the control signal 302. In other words, the control signal 302 may cause the application to generate an API call that is transmitted to the device driver, which generates an instruction that configures the GPU to render the stereoscopic video content based on a new binocular disparity. Thus, instead of using a GUI interface implemented by the application to control the depth of the stereoscopic video content, a user can instead use the interface 250 integrated into the frames of the pair of stereoscopic glasses 200.

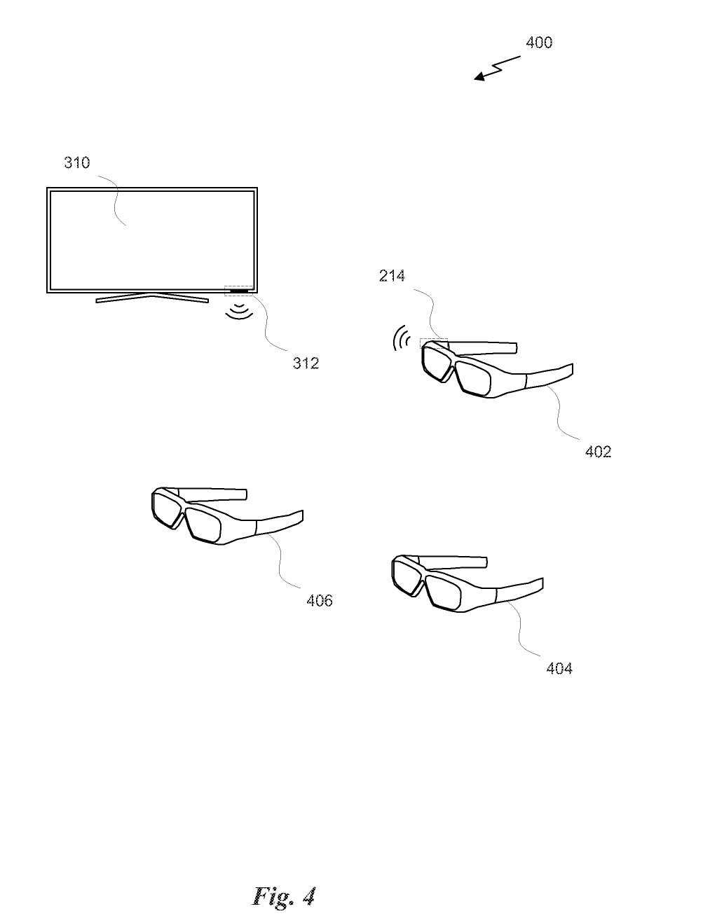

FIG. 4 illustrates a system 400 including multiple pairs of stereoscopic glasses, in accordance with one embodiment. As shown in FIG. 4, the system includes a first pair of stereoscopic glasses 402 coupled to a display device 310. Again, the display device is associated with a transceiver 312 that is configured to transmit the synchronization signal 304 to one or more pairs of stereoscopic glasses and receive the control signal 302 from the first pair of stereoscopic glasses 402, which includes a corresponding transceiver 214.

The system 400 may also include one or more additional pairs of stereoscopic glasses synchronized with the synchronization signal 304 for the display device 310. As shown in FIG. 4, the system 400 includes a second pair of stereoscopic glasses 404 and a third pair of stereoscopic glasses 406. Although not shown explicitly, each additional pair of stereoscopic glasses may include a receiver capable of detecting the synchronization signal 304.

The system 400 represents a system where a single pair of stereoscopic glasses is configured as a master and the additional pair(s) of stereoscopic glasses is configured as a slave(s). In other words, only a single set of stereoscopic glasses includes the interface 250 to control the binocular disparity of the stereoscopic video content, while additional pairs of stereoscopic glasses enable additional viewers to view such content.

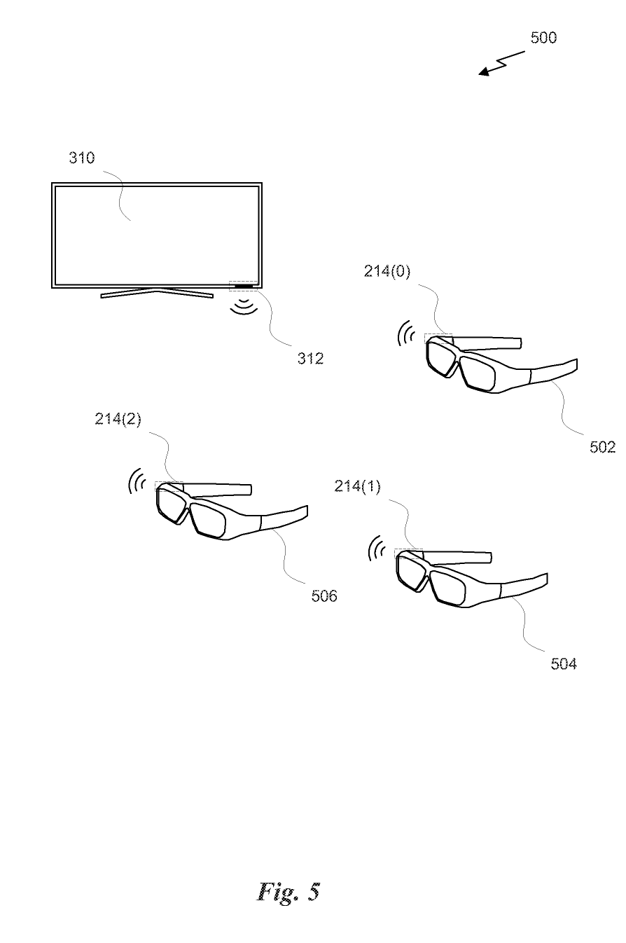

FIG. 5 illustrates a system 500 including multiple pairs of stereoscopic glasses, in accordance with another embodiment. The system 500 is similar to the system 400 except that each of the pairs of stereoscopic glasses includes the interface 250 and a transceiver 214. In other words, any single pair of stereoscopic glasses may be configured as the master and the other pair(s) may be configured as the slave(s). As shown in FIG. 5, the system 500 includes a single display device 310 including a transceiver 312. The system 500 also includes three pairs of stereoscopic glasses, a first pair of stereoscopic glasses 502, a second pair of stereoscopic glasses 504, and a third pair of stereoscopic glasses 506. The first pair of stereoscopic glasses 502 includes a first transceiver 214(0), the second pair of stereoscopic glasses 504 includes a second transceiver 214(1), and the third pair of stereoscopic glasses 506 includes a third transceiver 214(2).

In one embodiment, any of the pairs of stereoscopic glasses may be used to control the depth of the stereoscopic video content. For example, any of the users may simply increase or decrease the depth using the wheel included on their pair of stereoscopic glasses. It will be appreciated that any changes made to the depth by one user will be reflected in the content being displayed to all users (i.e., the depth cannot be controlled per individual viewer). In another embodiment, any of the pairs of stereoscopic glasses may be designated a master and then only that pair may be used to control the depth of the stereoscopic video content. For example, the wheel may be integrated with a button that allows a user to depress the wheel to designate that particular pair of stereoscopic glasses as the master.

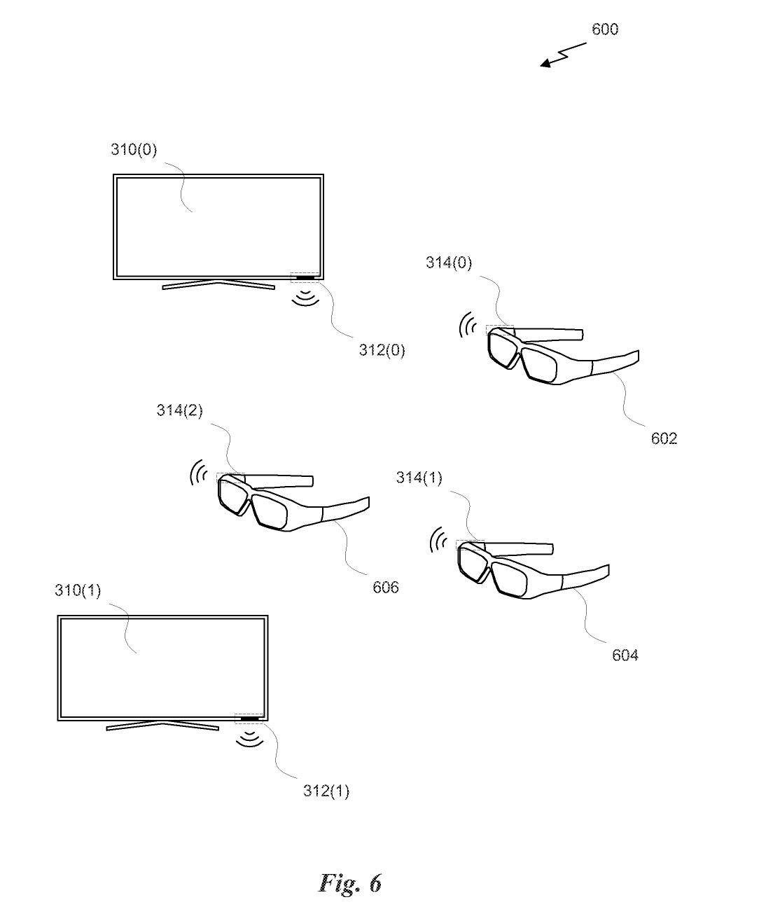

FIG. 6 illustrates a system 600 including multiple pairs of stereoscopic glasses, in accordance with yet another embodiment. The system 600 is similar to the system 500 except that the system 600 includes multiple display devices 310. As shown in FIG. 6, the system 600 includes a first display device 310(0) having a first transceiver 312(0) and a second display device 310(1) having a second transceiver 312(1). Each pair of stereoscopic glasses is coupled to a particular display device in the plurality of display devices, For example, a first pair of stereoscopic glasses 602 including a transceiver 314(0) is coupled to the first display device 310(0), a second pair of stereoscopic glasses 604 including a transceiver 314(1) is coupled to the second display device 310(1), and a third pair of stereoscopic glasses 606 including a transceiver 314(2) is coupled to the second display device 310(1).

Each display device 310 may generate a different synchronization signal for the pairs of stereoscopic glasses coupled to that particular display device 310. Thus, the first pair of stereoscopic glasses 602 is configured to watch stereoscopic video content generated for the first display device 310(0) and the second pair of stereoscopic glasses 604 and third pair of stereoscopic glasses 606 are configured to watch stereoscopic video content generated for the second display device 310(1). The first pair of stereoscopic glasses 602 may be configured as the master for the first display device 310(0) while the second pair of stereoscopic glasses 604 may be configured as the master for the second display device 310(1). Thus, the binocular disparity associated with the stereoscopic video content displayed on each display device may be controlled separately. In other words, even though the 3D content (i.e., 3D model data) may be the same for the stereoscopic video content generated for both the first display device 310(0) and the second display device 310(1). It will be appreciated that both display devices 310 may be coupled to a common stereoscopic processing unit 320 that generates two sets of stereoscopic video content. Alternatively, each display device 310 may be associated with distinct stereoscopic video content generated based on separate 3D model data.

Although the systems described above are described as being implemented using active stereoscopic glasses, the disclosure is not limited to such types of glasses. For example, the lenses 104 and 106 may be replaced with passive stereoscopic filters (i.e., polarized filters having different orientations or chromatic filters of different colors). However, such passive stereoscopic glasses will need to include a power source for the interface hardware as well as a transmitter to send the control signal to a receiver associated with a display device. Since passive stereoscopic glasses typically do not include a power source, such embodiments may be impractical.

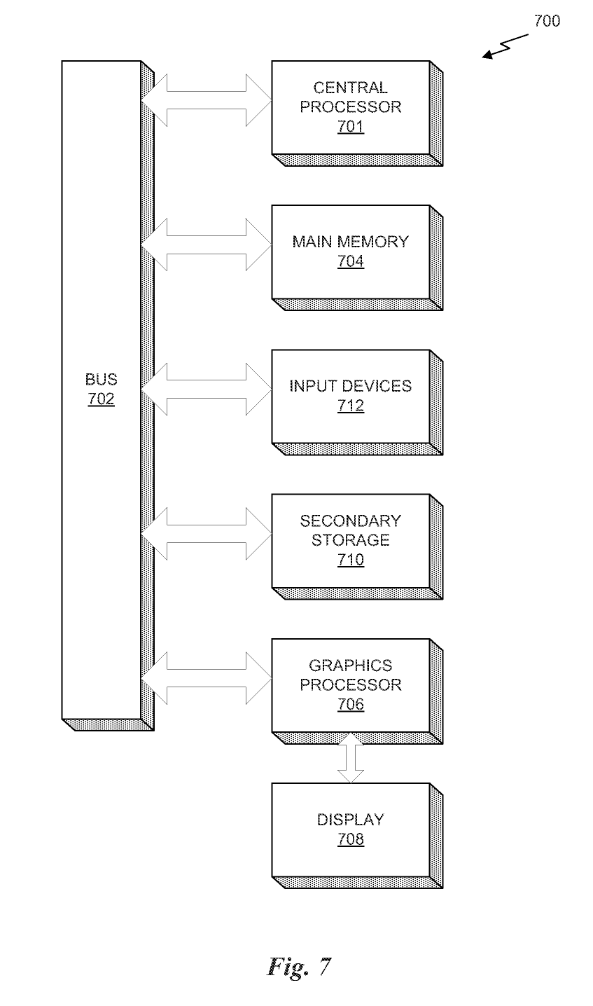

FIG. 7 illustrates an exemplary system 700 in which the various architecture and/or functionality of the various previous embodiments may be implemented. As shown, a system 700 is provided including at least one central processor 801 that is connected to a communication bus 702, The communication bus 702 may be implemented using any suitable protocol, such as PCI (Peripheral Component Interconnect), PCI-Express, AGP (Accelerated Graphics Port), HyperTransport, or any other bus or point-to-point communication protocol(s). The system 700 also includes a main memory 704, Control logic (software) and data are stored in the main memory 704 which may take the form of random access memory (RAM).

The system 700 also includes input devices 712, a graphics processor 706, and a display 708, i.e. a conventional CRT (cathode ray tube), LCD (liquid crystal display), LED (light emitting diode), plasma display or the like. User input may be received from the input devices 712, e.g., keyboard, mouse, touchpad, microphone, and the like. In one embodiment, the graphics processor 706 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 700 may also include a secondary storage 710. The secondary storage 710 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 704 and/or the secondary storage 710. Such computer programs, when executed, enable the system 700 to perform various functions. The memory 704, the storage 710, and/or any other storage are possible examples of computer-readable media.

In one embodiment, the architecture and/or functionality of the various previous figures may be implemented in the context of the central processor 701, the graphics processor 706, an integrated circuit (not shown) that is capable of at least a portion of the capabilities of both the central processor 701 and the graphics processor 706, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 700 may take the form of a desktop computer, laptop computer, server, workstation, game consoles, embedded system, and/or any other type of logic. Still yet, the system 700 may take the form of various other devices including, but not limited to a personal digital assistant (PDA) device, a mobile phone device, a television, etc.

Further, while not shown, the system 700 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An apparatus comprising:
a first lens associated with a first image in a stereoscopic image pair;
a second lens associated with a second image in the stereoscopic image pair;
a frame that supports the first lens and the second lens; and
an interface integrated with the frame, wherein the interface enables a user to adjust a parameter associated with the stereoscopic image pair.

2. The apparatus of claim 1, wherein the parameter is a binocular disparity

3. The apparatus of claim 2, wherein the interface comprises a wheel.

4. The apparatus of claim 3, wherein the wheel is configured to increase the binocular disparity of the stereoscopic image pair when the wheel spins counterclockwise and decrease the binocular disparity when the wheel spins clockwise.

5. The apparatus of claim 2, wherein the interface comprises at least two buttons, and wherein a first button of the at least two buttons is configured to increase the binocular disparity of the stereoscopic image pair when the first button is depressed and a second button of the at least two buttons is configured to decrease the binocular disparity when the second button is depressed.

6. The apparatus of claim 1, wherein the apparatus comprises active stereoscopic glasses further including a power source.

7. The apparatus of claim 6, further comprising a first transceiver integrated with the frame and configured to receive a synchronization signal generated by a second transceiver associated with a display device and transmit a control signal corresponding to the interface to the second transceiver associated with the display device.

8. The apparatus of claim 6, wherein the apparatus further includes a button to enable/disable the display of stereoscopic video content on a display device.

9. The method of claim 1, the apparatus comprises passive stereoscopic glasses, and wherein the first lens comprises a polarized filter having a first orientation and the second lens comprises a polarized filter having a second orientation.

10. The method of claim 9, wherein the passive stereoscopic glasses further include:
a power source; and
a transmitter configured to transmit a control signal corresponding to the interface to a receiver associated with the display device.

11. A system, comprising:
a display device configured to display stereoscopic video content; and
a pair of stereoscopic glasses that include:
a first lens associated with a first image in a stereoscopic image pair,
a second lens associated with a second image in the stereoscopic image pair,
a frame that supports the first lens and the second lens, and
an interface integrated in the frame, wherein the interface enables a user to adjust a parameter associated with the stereoscopic image pair.

12. The system of claim 11, wherein the parameter is a binocular disparity.

13. The system of claim 12, wherein the interface comprises a wheel, and wherein the interface is configured to increase the binocular disparity of the stereoscopic image pair when the wheel spins counterclockwise and decrease the binocular disparity when the wheel spins clockwise.

14. The system of claim 11, further comprising a second pair of stereoscopic glasses, wherein the first pair of stereoscopic glasses is configured as a master and the second pair of stereoscopic glasses is configured as a slave.

15. The system of claim 14, wherein the interface implements a protocol that enables the second pair of stereoscopic glasses to be reconfigured as the master and the first pair of stereoscopic glasses to be configured as the slave.

16. The system of claim 11, further comprising;
a second display device configured to display stereoscopic video content; and
a second pair of stereoscopic glasses.

17. The system of claim 16, wherein the first pair of stereoscopic glasses is configured to control a first binocular disparity of the stereoscopic image pair displayed on the first display device and the second pair of stereoscopic glasses is configured to control a second binocular disparity of a second stereoscopic image pair displayed on the second display device.

18. The system of claim 11, further comprising a graphics processing unit, coupled to the display device and configured to generate the stereoscopic video content for display based on the parameter.

19. The system of claim 18, further comprising a host processor configured to execute a device driver, wherein the device driver receives a control signal from the interface to adjust the parameter.

20. The system of claim 18, further comprising an application configured to receive the control signal and generate an API call for a device driver for the graphics processing unit that adjusts the parameter.
